(19) United States
(12) Patent Application Publication
(10) Pub. No.: US 2019/0066897 A1
(43) Pub. Date: Feb. 28, 2019

(54) COIL PART

(71) Applicant: Panasonic Intellectual Property Management Co., Ltd., Osaka (JP)

(72) Inventors: Junichi KOTANI, Hyogo (JP); Toshiyuki ASAHI, Osaka (JP); Nobuya MATSUTANI, Osaka (JP); Hironori NAGASAKI, Osaka (JP)

(21) Appl. No.: 16/082,947

(22) PCT Filed: Mar. 9, 2017
(86) PCT No.: PCT/JP2017/009356

§ 371 Date: Sep. 7, 2018

(30) Foreign Application Priority Data
Mar. 11, 2016 (JP) 2016-048268
Mar. 11, 2016 (JP) 2016-048269
Mar. 11, 2016 (JP) 2016-048270

(51) Int. Cl. H01F 27/02; H01F 27/32; H02K 15/12; H01F 27/255; H01F 41/02; H01F 41/12

(52) U.S. Cl. CPC H01F 27/02; H01F 27/32; H02K 15/12; H01F 2027/406; H01F 41/0246; H01F 41/12; H01F 27/255

(57) ABSTRACT

A coil part includes two coils, two first molded bodies, and a second molded body. The two first molded bodies serving as electrical insulation individually cover the two coils. The second molded body serving as electrical insulation integrally covers the two first molded bodies. The second molded body has a modulus of elasticity lower than a modulus of elasticity of each of the two first molded bodies.

### TECHNICAL FIELD

The present invention generally relates to coil parts, and specifically, to a coil part including a coil covered with a molded body.

### BACKGROUND ART

A coil part (reactor) including a coil covered with a resin molded body is known (see, for example, Patent Literature 1). The coil part described in Patent Literature 1 includes two coils integrally covered with a resin molded body.

In the coil part, when the resin molded body covering the coils has a large size, a void is more likely to occur during molding of the resin molded body, which degrades heat dissipation characteristics.

### CITATION LIST

### Patent Literature

Patent Literature 1: JP 2012-134562 A

### SUMMARY OF INVENTION

In view of the foregoing, it is an object of the present invention to provide a coil part which enables heat dissipation characteristics to be improved.

A coil part of a first aspect according to the present invention includes two coils, two first molded bodies, and a second molded body. The two first molded bodies serving as electrical insulation individually cover the two coils. The second molded body serving as electrical insulation integrally covers the two first molded bodies. The second molded body has a modulus of elasticity lower than a modulus of elasticity of each of the two first molded bodies.

In a coil part of a second aspect according to the present invention referring to the first aspect, each of the two first molded bodies has a thermal conductivity higher than a thermal conductivity of the second molded body.

In a coil part of a third aspect according to the present invention referring to the first or second aspect, each of the two first molded bodies and the second molded body contains a resin and a filler having a higher thermal conductivity than the resin. A filler content of each of the two first molded bodies is higher than a filler content of the second molded body.

In a coil part of a fourth aspect according to the present invention referring to any one of the first to third aspects, each of the two first molded bodies has specific gravity higher than specific gravity of the second molded body.

A coil part of a fifth aspect according to the present invention referring to any one of the first to fourth aspects further includes a first magnetic member and a second magnetic member. The first magnetic member is magnetically connectable to the two coils. The second magnetic member is magnetically connectable to the two coils. Each of the two first molded bodies has a first insertion hole, a second insertion hole, and a limiter. The first insertion hole is formed on one side in an axial direction of a corresponding one of the two coils. A part of the first magnetic member is inserted into the first insertion hole. The second insertion hole is formed on the other side in the axial direction of the corresponding one of the two coils. A part of the second magnetic member is inserted into the second insertion hole. The limiter limits at least one of an insertion distance of the first magnetic member into the first insertion hole and an insertion distance of the second magnetic member into the second insertion hole.

A coil part of a sixth aspect according to the present invention referring to any one of the first to fifth aspects further includes a temperature detector. The temperature detector is configured to detect a temperature of the two coils. At least one of the two first molded bodies includes a positioning section for positioning the temperature detector.

### BRIEF DESCRIPTION OF DRAWINGS

FIG. 1A is a plan view illustrating a coil part according to one embodiment of the present invention, and FIG. 1B is a front view illustrating the coil part;

FIG. 2A is a sectional view taken along line A-A of FIG. 1B, and FIG. 2B is a sectional view taken along line B-B of FIG. 1A;

FIG. 3A is a front view illustrating a first molded body of the coil part, FIG. 3B is a plan view illustrating the first molded body of the coil part, and FIG. 3C is a side view illustrating the first molded body of the coil part;

FIG. 4 is an enlarged sectional view illustrating a part of a first molded body of a coil part according to a first variation of the one embodiment of the present invention;

FIG. 5A is a partly cutaway front view illustrating a first molded body of a coil part according to a second variation of the one embodiment of the present invention, and FIG. 5B is a partly cutaway side view illustrating the first molded body of the coil part of the second variation;

FIG. 6A is a sectional view illustrating a coil part according to a third variation of the one embodiment of the present invention, and FIG. 6B is a sectional view illustrating the coil part of the third variation;

FIG. 7A is a sectional view illustrating another configuration of the coil part of the third variation, and FIG. 7B is a sectional view illustrating another configuration of the coil part of the third variation;

FIG. 8A is a sectional view illustrating another configuration of the coil part of the third variation, and FIG. 8B is a sectional view illustrating another configuration of the coil part of the third variation;

FIG. 9A is a sectional view illustrating another configuration of the coil part of the third variation, and FIG. 9B is a sectional view illustrating another configuration of the coil part of the third variation;

FIG. 10A is a sectional view illustrating another configuration of the coil part of the third variation, and FIG. 10B is a sectional view illustrating another configuration of the coil part of the third variation;

FIG. 11A is a sectional view illustrating a coil part according to a fourth variation of the one embodiment of the present invention, and FIG. 11B is a sectional view illustrating the coil part of the fourth variation; and

FIG. 12A is a sectional view illustrating a coil part according to a fifth variation of the one embodiment of the present invention, and FIG. 12B is a sectional view illustrating the coil part of the fifth variation.

### DESCRIPTION OF EMBODIMENTS

An embodiment of the present invention will be described below with reference to the drawings. Note that the figures described in the following embodiment are schematic views, and the dimensional ratio of each component does not necessarily correspond to the actual dimensional ratio.

### Embodiment

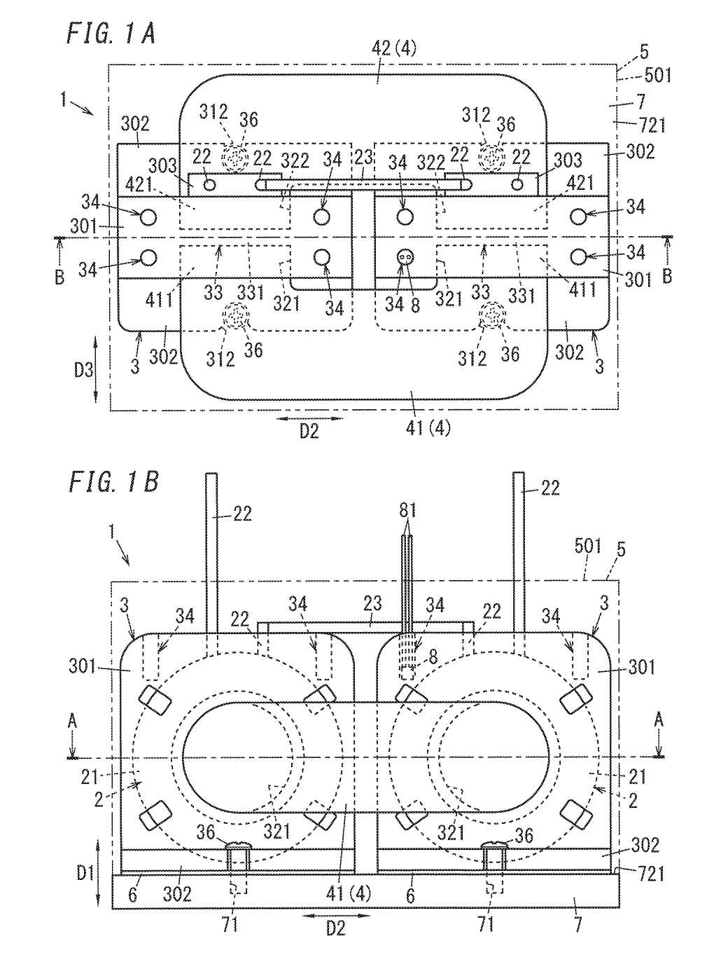

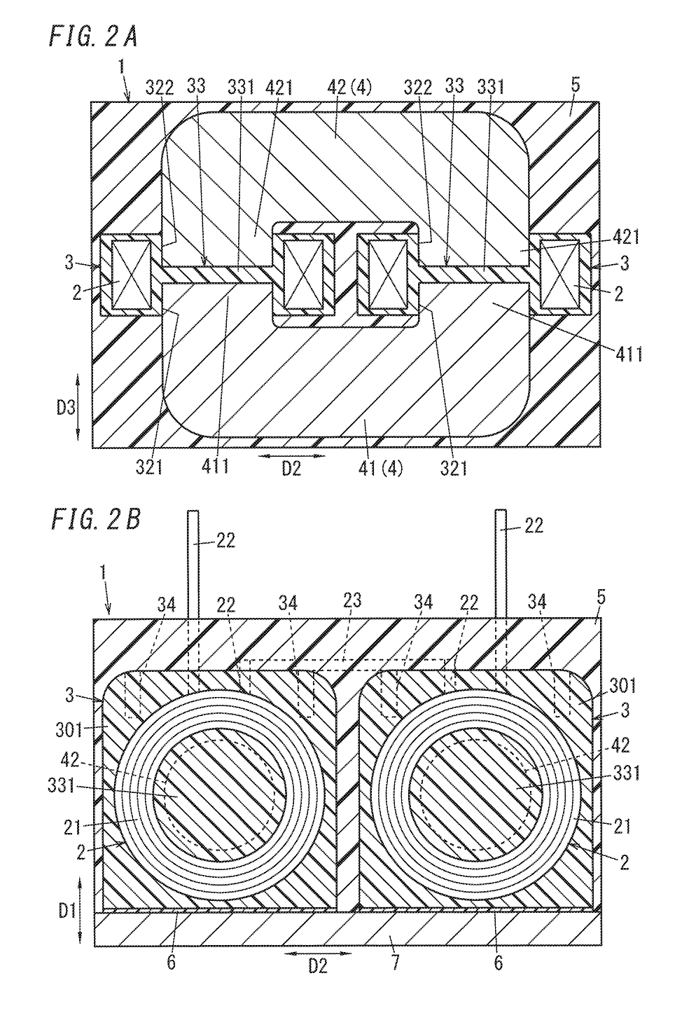

FIG. 1A is a plan view illustrating a coil part 1 of the present embodiment, FIG. 1B is a front view illustrating the coil part 1, FIG. 2A is a sectional view taken along line A-A of FIG. 1B, and FIG. 2B is a sectional view taken along line B-B of FIG. 1A. In the following description, the up-and-down direction in FIG. 1B is defined as a first direction D1, the right-and-left direction in FIG. 1B is defined as a second direction D2, and the up-and-down direction in FIG. 1A is defined as a third direction D3. Arrows representing the first direction D1, second direction D2, and third direction D3 in the figures are indicated merely to clarify the directions and have no entity.

The coil part 1 of the present embodiment is a reactor including two coils 2 connected in series to each other and two magnetic members 4 (a first magnetic member 41 and a second magnetic member 42) magnetically connected to the respective two coils 2. The two coils 2 are individually encapsulated in two first molded bodies 3. The two first molded bodies 3 are integrally encapsulated in a second molded body 5. The coil part 1 of the present embodiment is included in, for example, a drive circuit of a motor in an electric vehicle. Note that the application of the coil part 1 is not limited to electric vehicles, but the coil part 1 may be adopted in other applications.

The coil part 1 of the present embodiment will be described in detail below.

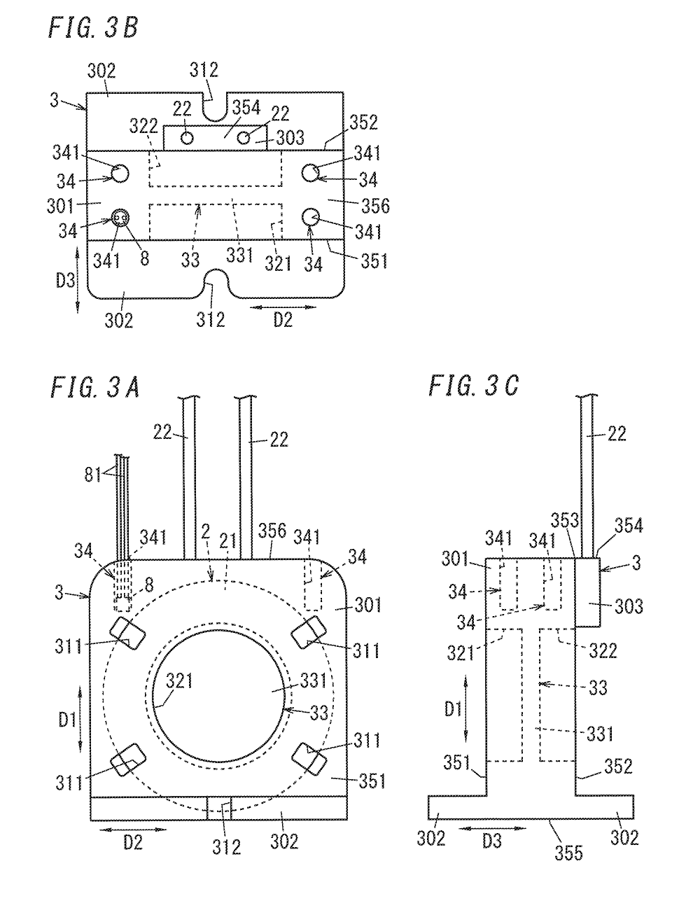

FIGS. 3A, 3B, 3C are respectively a front view, a plan view, and a side view illustrating the first molded body 3.

Each of the two coils 2 includes a winding wire 21 and a pair of terminals 22. The winding wire 21 is a conductive line wound around a virtual shaft as the center. The virtual shaft extends along the third direction D3. The pair of terminals 22 is a pair of ends of the conductive line. The two coils 2 correspond to the two first molded bodies 3 on a one-to-one basis. The two coils 2 are individually encapsulated in the two first molded bodies 3. The two coils 2 have a common configuration.

Each of the two first molded bodies 3 is made of a material containing a resin and a filler. As the resin contained in each first molded body 3, for example, an epoxy resin, a silicone resin, or poly phenylene sulfide (PPS) is adopted. The filler is, for example, a so-called thermal conductive filler such as alumina, silica, boron nitride, or aluminum nitride and has a thermal conductivity higher than the resin contained in each first molded body 3. Each first molded body 3 contains the filler so as to improve the thermal conductivity. The two first molded bodies 3 have a common configuration.

Each first molded body 3 is formed by a molding method such as transfer molding or injection molding, and one coil 2 is insert molded. The first molded bodies 3 each include a body 301 covering the coil 2 and a pair of seats 302 via which each first molded body 3 is to be fixed to a heat dissipation member 7.

The body 301 has a substantially square shape when externally viewed in the third direction D3. The body 301 covers the winding wire 21 of the coil 2. The body 301 has a first surface 351 (a left side surface in FIG. 3C) and a second surface 352 (a right side surface in FIG. 3C). The first surface 351 and the second surface 352 are orthogonal to the third direction D3. Each of the first surface 351 and the second surface 352 has a plurality of (in FIG. 3A, four) holes 311. Note that the holes 311 in the second surface 352 are omitted in the figure. The plurality of holes 311 are holes formed by a jig which holds the coil 2 by clamping the coil 2 in the third direction D3 so that the coil 2 does not move in a mold during formation of the first molded body 3.

The first surface 351 of the body 301 has a first insertion hole 321 in which an end 411 of the first magnetic member 41 is inserted. The second surface 352 of the body 301 has a second insertion hole 322 in which an end 421 of the second magnetic member 42 is inserted. The first insertion hole 321 is a round recess formed on one side in the axial direction of the coil 2. The second insertion hole 322 is a round recess formed on the other side in the axial direction of the coil 2. The “axial direction of the coil 2” means a direction (third direction D3) along the virtual shaft of the winding wire 21 of the coil 2. A part of an inner peripheral surface of the first insertion hole 321 and a part of an inner peripheral surface of the second insertion hole 322 face the winding wire 21. A partition 331 separating the first insertion hole 321 from the second insertion hole 322 is provided between the first insertion hole 321 and the second insertion hole 322 in third direction D3. The partition 331 is a part of the first molded body 3 and also serves as a bottom part of the first insertion hole 321 and a bottom part of the second insertion hole 322.

Moreover, the second surface 352 of the body 301 is provided with a rectangular protrusion 303 protruding from a first end 353 (an upper end in FIG. 3C) in the first direction D1 of the body 301 toward one side in the third direction D3. The pair of terminals 22 arranged in the second direction D2 protrudes from a first surface 354 (an upper surface in FIG. 3C) of the protrusion 303. The first surface 354 is orthogonal to the first direction D1.

The pair of seats 302 protrudes from a second end 355 (a lower end in FIG. 3C) in the first direction D1 of the body 301 toward one side and the other side in the third direction D3. Each seat 302 has a rectangular plate shape whose thickness direction is the first direction D1. Each seat 302 has an indentations 312 formed in an edge in the third direction D3 of the seat 302. The indentation 312 extends through the seat 302 in the first direction D1. Screws 36 for fixing the first molded body 3 to the heat dissipation member 7 are inserted into the indentations 312. The first molded body 3 is fixed to the heat dissipation member 7 with the screws 36.

The heat dissipation member 7 is made of metal such as aluminum and has a rectangular plate shape. The heat dissipation member 7 has a first surface 721 (in FIG. 1B, an upper surface) orthogonal to the first direction D1. The first surface 721 has screw holes 71 to which the screws 36 are connected. The first molded body 3 is fixed to the heat dissipation member 7 by connecting the screws 36 to the screw holes 71 via the indentations 312 of the first molded body 3. The two first molded bodies 3 are arranged in the second direction D2 and fixed to the heat dissipation member 7. The distance between the coil 2 encapsulated by the first molded body 3 and the heat dissipation member 7 to which the first molded body 3 is fixed serves as an electrical insulation distance between the coil 2 and the heat dissipation member 7. Note that the heat dissipation member 7 may be configured to also serve as a case or a chassis in which the coil part 1 is provided.

A thermal bonding member 6 which thermally connects the first molded body 3 to the heat dissipation member 7 is provided between the first molded body 3 and the heat dissipation member 7. The thermal bonding member 6 is made of a material containing a resin and a filler. As the resin contained in the thermal bonding member 6, for example, an epoxy resin is adopted. The filler is, for example, a so-called thermal conductive filler such as alumina, silica, boron nitride, or aluminum nitride and has a thermal conductivity higher than the resin contained in the thermal bonding member 6. The thermal bonding member 6 contains the filler so as to improve the thermal conductivity. The thermal bonding member 6 is disposed between the first molded body 3 and the heat dissipation member 7 such that the thermal bonding member 6 is tightly in contact with both the first molded body 3 and the heat dissipation member 7. This reduces the thermal resistance between the first molded body 3 and the heat dissipation member 7, thereby enabling the heat dissipation characteristic of the first molded body 3 to be improved.

Moreover, the thermal bonding member 6 has a function of connecting the first molded body 3 to the heat dissipation member 7 through curing. Thus, the first molded body 3 is fixed to the heat dissipation member 7 with both the screws 36 and the thermal bonding member 6. Thus, it becomes possible to improve the fixing strength of the first molded body 3 with respect to the heat dissipation member 7. When the thermal bonding member 6 has a function of connecting the first molded body 3 to the heat dissipation member 7, the screws 36 may be omitted.

Note that the thermal bonding member 6 may contain silicone grease. In this case, the thermal bonding member 6 does not have the function of connecting the first molded body 3 to the heat dissipation member 7, and therefore, the screws 36 are essential components.

The two first molded bodies 3 are arranged in the second direction D2, and the pair of terminals 22 arranged in the second direction D2 protrude from the first molded bodies 3. One of the pair of terminals 22 of a one of the two coils 2 is electrically connected to one of the pair of terminals 22 of the other of the two coils 2 via a connector 23. The connector 23 is formed of, for example, a conductive line or a conductive plate and electrically connects the one end of one of the two coils 2 to one end of the other of the two coils 2. Thus, the two coils 2 are electrically connected in series and can be deemed to be one coil.

Each of the first magnetic member 41 and the second magnetic member 42 is formed of, for example, a powder magnetic core and has a substantially U shape when externally viewed in the first direction D1. The first magnetic member 41 has the pair of ends 411. Each end 411 has a round cross section when viewed in the third direction D3, and the diameter of the round cross section is slightly smaller than the diameter of the first insertion hole 321. The end 411 is thus insertable into the first insertion hole 321. Each of the pair of ends 411 of the first magnetic member 41 is inserted into the first insertion hole 321 until each end 411 contacts the partition 331 serving as a bottom part of the first insertion hole 321. Each end 411 faces the coil 2 via a periphery of the first insertion hole 321 of the first molded body 3. Moreover, the second magnetic member 42 includes the pair of ends 421. Each end 421 has a round cross section when viewed in the third direction D3, and the diameter of the round cross section is slightly smaller than the diameter of the second insertion hole 322. The end 421 is thus insertable into the second insertion hole 322. Each of the pair of ends 421 of the second magnetic member 42 is inserted into the second insertion hole 322 until each end 421 contacts the partition 331 serving as a bottom part of the second insertion hole 322. Each end 421 faces the coil 2 via a periphery of the second insertion hole 322 of the first molded body 3. That is, the pair of ends 411 of the first magnetic member 41 and the pair of ends 421 of the second magnetic member 42 are arranged on an inner side of the two coils 2. Thus, the first magnetic member 41 and the second magnetic member 42 are magnetically connected to the two coils 2. When the first magnetic member 41 and the second magnetic member 42 are not distinguished from each other, they are referred to as magnetic members 4.

Moreover, the partition 331 of each first molded body 3 also serves as a limiter 33 which limits insertion distances of the first magnetic member 41 and the second magnetic member 42. The limiter 33 limits the insertion distance of the first magnetic member 41 into the first insertion hole 321 to the dimension of the first insertion hole 321 in the third direction D3. Moreover, the limiter 33 limits the insertion distance of the second magnetic member 42 into the second insertion hole 322 to the dimension of the second insertion hole 322 in the third direction D3. In other words, the insertion distance of the first magnetic member 41 into the first insertion hole 321 and the insertion distance of the second magnetic member 42 into the second insertion hole 322 are limited by the limiter 33.

Moreover, the pair of ends 411 of the first magnetic member 41 and the pair of ends 421 of the second magnetic member 42 face each other with the partitions 331 of the two first molded bodies 3 provided therebetween in the third direction D3. Since each partition 331 is a part of the first molded body 3 and is a non-magnetic body, the partition 331 serves as a magnetic gap. The dimension of the partition 331 in the third direction D3 corresponds to a gap length between the first magnetic member 41 and the second magnetic member 42.

The coil part 1 of the present embodiment includes a temperature detector 8. The temperature detector 8 includes, for example, a thermistor or a thermocouple and detects the temperature of the coil 2. The first molded body 3 includes positioning sections 34 for positioning the temperature detector 8.

Each positioning section 34 is a recess 341 formed in a third surface 356 (in FIG. 3A, an upper surface) of the body 301. The third surface 356 is orthogonal to the first direction D1. The recess 341 is dimensioned such that the temperature detector 8 is insertable into the recess 341. The temperature detector 8 is positioned by being inserted into the recess 341 until the temperature detector 8 contacts a bottom part of the recess 341 serving as the positioning section 34. Moreover, in the third surface 356 of the body 301, the positioning section 34 includes a plurality of (in FIG. 3B, four) positioning sections 34. Specifically, the four positioning sections 34 are provided in the vicinity of four corners in the third surface 356 of the body 301. The coil part 1 of the present embodiment includes the two first molded bodies 3, and the temperature detector 8 is positioned by any one of the four positioning sections 34 included in one of the two first molded bodies 3. Specifically, as illustrated in FIGS. 1A and 1B, the two first molded bodies 3 are arranged in the second direction D2, and the temperature detector 8 is positioned by one of two positioning sections 34 included in the four positioning sections 34 of one of the first molded bodies 3 and located on a side facing the other of the first molded bodies 3. That is, the temperature detector 8 is arranged in a location which is located between the two coils 2 in the coil part 1 and in which the temperature easily becomes relatively high.

The second molded body 5 is made of a material containing a resin and a filler. As the resin contained in the second molded body 5, for example, an epoxy resin, a silicone resin, or a urethane resin is adopted. The filler is, for example, a so-called thermal conductive filler such as alumina, silica, boron nitride, or aluminum nitride and has a thermal conductivity higher than the resin contained in the second molded body 5. The second molded body 5 contains the filler so as to improve the thermal conductivity.

The second molded body 5 is formed by a molding method such as potting to have a rectangular parallelepiped shape on a side facing the first surface 721 of the heat dissipation member 7. The second molded body 5 integrally covers the two first molded bodies 3, the first magnetic member 41, the second magnetic member 42, the connector 23, and the temperature detector 8, thereby accommodating these components in the second molded body 5. Thus, the two first molded bodies 3, the first magnetic member 41, the second magnetic member 42, the connector 23, and the temperature detector 8 are fixed and protected in an assembled state by the second molded body 5. Moreover, the plurality of recesses 341 serving as the plurality of positioning sections 34 of the first molded body 3 are filled with the second molded body 5. The temperature detector 8 is fixed to the positioning section 34 through curing of a molding material of the second molded body 5. The second molded body 5 has a first surface 501 (in FIG. 1B, an upper surface) which is orthogonal to the first direction D1 and from which one of the terminals 22 of each of the two coils 2 and a pair of terminals 81 of the temperature detector 8 protrude. The two terminals 22 protruding from the first surface 501 of the second molded body 5 function as terminals of the coil part 1.

As described above, each of the first molded bodies 3, the second molded body 5, and the thermal bonding member 6 is made of a material containing a resin and a filler. The first molded bodies 3, the second molded body 5, and the thermal bonding member 6 are different from one another in terms of filler content percentage (packing factor). The relationship A3>A1>A2 holds true, where A1 is the filler content of each first molded body 3, A2 is the filler content of the second molded body 5, and A3 is the filler content of the thermal bonding member 6. That is, the filler content percentage decreases in an order of the thermal bonding member 6, the first molded bodies 3, and the second molded body 5.

Moreover, the first molded bodies 3, the second molded body 5, and the thermal bonding member 6 are different from one another in terms of specific gravity. The relationship B3>B1>B2 holds true, where B1 is the specific gravity of each first molded body 3, B2 is the specific gravity of the second molded body 5, and B3 is the specific gravity of the thermal bonding member 6. That is, the specific gravity decreases in an order of the thermal bonding member 6, the first molded bodies 3, and the second molded body 5.

The filler content percentage and the specific gravity influence the thermal conductivities of the components. When the filler has the same quality of material, a component having a higher filler content percentage has a higher thermal conductivity. Moreover, a component having a higher specific gravity has a higher thermal conductivity. The relationship λ3>λ1>λ2 holds true, where λ1 is the thermal conductivity of each first molded body 3, λ2 is the thermal conductivity of the second molded body 5, and λ3 is the thermal conductivity of the thermal bonding member 6. That is, the thermal conductivity decreases in an order of the thermal bonding member 6, the first molded bodies 3, and the second molded body 5. Note that the first molded body 3, the second molded body 5, and the thermal bonding member 6 may be different from one another in terms of the quality of material of the filler contained therein.

The thermal conductivity λ1 of the first molded body 3 is preferably 2 W/mK to 3 W/mK. The thermal conductivity λ2 of the second molded body 5 is preferably equal to or higher than 0.5 W/mK. Moreover, the thermal conductivity λ2 of the second molded body 5 is preferably lower than or equal to 2 W/mK. The thermal conductivity λ3 of the thermal bonding member 6 is preferably higher than or equal to 3 W/mK. Examples of the filler content, the quality of material of the filler, the specific gravity, and the thermal conductivity of each first molded body 3, the second molded body 5, and the thermal bonding member 6 are shown below. In each first molded body 3, the filler content is a mass percentage (wt. %) of 75 to 95, the quality of material of the filler is silica, alumina, or the like, the specific gravity is 2.1 to 2.9, and the thermal conductivity is 2 W/mK to 3 W/mK. In the second molded body 5, the filler content is a mass percentage of 70 to 80, the quality of material of the filler is silica as a main component, the specific gravity is 1.7 to 2.2, and the thermal conductivity is 0.6 W/mK to 1.1 W/mK. In the thermal bonding member 6, the filler content is a mass percentage of 75 to 99, the quality of material of the filler is silica, alumina, or the like, the specific gravity is 2.5 to 4.0, and the thermal conductivity is 3.0 W/mK to 6.0. The first molded bodies 3, the second molded body 5, and the thermal bonding member 6 are configured such that the filler content percentage, the specific gravity, and the thermal conductivity decrease, within the above-listed range of numerical values, in an order of the thermal bonding member 6, the first molded bodies 3, and the second molded body 5. Note that the numerical values are mere examples and are not limited to those in the embodiment but may be other numerical values.

Moreover, the filler content percentage influences the fluidity in a case where the member containing the filler is in a molten state. A higher filler content percentage leads to a lower fluidity in the case where the member is in the molten state, in other words, to a higher viscosity of the component.

The first molded bodies 3 and the second molded body 5 include a component having elasticity in a cured state. The modulus of elasticity of each first molded body 3 and the modulus of elasticity of the second molded body 5 are different from each other. The modulus of elasticity of the second molded body 5 is lower than the modulus of elasticity of each first molded body 3. That is, in the cured state, the second molded body 5 is softer than the first molded body 3.

<Fabrication Method>

Next, a method for fabricating the coil part 1 of the present embodiment will be described. The method for fabricating the coil part 1 of the present embodiment includes a preparation step, a first formation step, an assembling step, and second formation step.

The preparation step is a step of preparing a coil 2 including a winding wire 21 formed by winding a conductive line and a pair of terminals 22 which are a pair of ends of the conductive line. The coil part 1 of the present embodiment includes two coils 2, and therefore, two coils 2 are prepared in the preparation step.

The first formation step is a step of forming two first molded bodies 3 by a molding method such as transfer molding or injection molding to individually cover the two coils 2 prepared in the preparation step. In the first formation step, a plurality of recesses 341 are formed in each of the two first molded bodies 3. The plurality of recesses 341 are positioning sections 34 for positioning a temperature detector 8. Moreover, in the first formation step, a partition 331 is formed in each of the two first molded bodies 3. The partition 331 serves as a limiter 33 for limiting both the insertion distance of a first magnetic member 41 into a first insertion hole 321 and the insertion distance of a second magnetic member 42 into a second insertion hole 322.

The assembling step is a step of assembling the two first molded bodies 3 formed in the first formation step, a connector 23, the first magnetic member 41, the second magnetic member 42, the temperature detector 8, thermal bonding members 6, and a heat dissipation member 7. In the assembling step, the two first molded bodies 3 formed in the first formation step are fixed to the heat dissipation member 7 via the thermal bonding members 6. Then, one of the terminals 22 of one of the two coils 2 is electrically and mechanically connected via the connector 23 to one of the terminals 22 of the other of the two coils 2. Moreover, the first magnetic member 41 is inserted into the first insertion holes 321 until a pair of ends 411 of the first magnetic member 41 contacts bottom parts (partitions 331) of the first insertion holes 321 formed in the two first molded bodies 3. The second magnetic member 42 is inserted into the second insertion holes 322 until a pair of ends 421 of the second magnetic member 42 contacts bottom parts (partitions 331) of the second insertion holes 322 formed in the two first molded bodies 3. The temperature detector 8 is inserted into one of two recesses 341 included in the plurality of recesses 341 formed in one of the two first molded bodies 3 and located on a side facing the other of the first molded bodies 3. Note that the order of assembling steps is not limited to the order described above, but the order may be changed.

The second formation step is a step of forming a second molded body 5 by a molding method such as potting to integrally cover the two first molded bodies 3, the connector 23, the first magnetic member 41, the second magnetic member 42, and the temperature detector 8 which are assembled in the assembling step. In the second formation step, the second molded body 5 which is cured fixes the two first molded bodies 3, the connector 23, the first magnetic member 41, the second magnetic member 42, and the temperature detector 8 in an assembled state.

<Advantages>

Next, advantages provided by the coil part 1 of the present embodiment will be described.

The first molded bodies 3 individually cover the coils 2. Thus, the first molded bodies 3 can be downsized, and the occurrence of a void during formation of the first molded bodies 3 is reduced. This improves the heat dissipation characteristic of the first molded bodies 3, which enables the coils 2 to efficiently dissipate heat. Moreover, the filler content of each first molded body 3 is higher than that of the filler contained in the second molded body 5, and the fluidity of the molding material of each first molded body 3 is lower than that of the second molded body 5. However, since the first molded bodies 3 are configured to individually cover the coils 2, it is possible to downsize the first molded bodies 3. Thus, the first molded bodies 3 are less likely to lead to the occurrence of a void due to low fluidity of the molding material. Furthermore, the filler content of each first molded body 3 and the specific gravity of each first molded body 3 are higher than those of the second molded body 5, and each first molded body 3 has a higher thermal conductivity than the second molded body 5. This further improves the heat dissipation characteristic of the first molded bodies 3 and enables the coils 2 to more efficiently dissipate heat. In other words, the heat dissipation characteristic of the coil part 1 is improved.

The filler content of the second molded body 5 is lower than that of the filler contained in each first molded body 3, and the fluidity of the molding material of the second molded body 5 is higher than that of each first molded body 3. Thus, the second molded body 5 has a larger volume than the first molded body 3, but it becomes possible to reduce the occurrence of a void during formation of the second molded body 5. Moreover, the second molded body 5 is made of a material containing a filler. This improves the heat dissipation characteristic of the second molded body 5 and enables the two first molded bodies 3 (coils 2), the first magnetic member 41, and the second magnetic member 42 encapsulated in the second molded body 5 to efficiently dissipate heat. Thus, the heat dissipation characteristic of the coil part 1 can further be improved.

Moreover, the modulus of elasticity of the second molded body 5 is lower than that of the first molded body 3. Thus, vibration and noise generated due to a magnetostriction phenomenon of the magnetic members 4 when an alternate current flows through the coil 2 can be reduced by being absorbed by the second molded body 5.

A thermal bonding member 6 which thermally connects the first molded body 3 to the heat dissipation member 7 is provided between the first molded body 3 and the heat dissipation member 7. The thermal bonding member 6 reduces the thermal resistance between the first molded body 3 and the heat dissipation member 7, thereby enabling the heat dissipation characteristic of the first molded body 3 to be improved. This enables the coils 2 encapsulated in the first molded bodies 3 to efficiently dissipate heat. Moreover, the filler content of the thermal bonding member 6 and the specific gravity of the thermal bonding member 6 are higher than those of each first molded body 3, and the thermal bonding member 6 has a higher thermal conductivity than each first molded body 3. Thus, it becomes possible to farther improve the heat dissipation characteristic of the first molded body 3 and to enable the coils 2 to more efficiently dissipate heat.

Moreover, the thermal bonding member 6 connects the first molded bodies 3 to the heat dissipation member 7. Thus, it becomes possible to improve the fixing strength of the first molded body 3 with respect to the heat dissipation member 7. Moreover, connecting the first molded body 3 to the heat dissipation member 7 via the thermal bonding member 6 reduces molding materials of the second molded body 5 entering between each first molded body 3 and the heat dissipation member 7 during formation of the second mold 5. Thus, degradation of the heat dissipation characteristic of the first molded bodies 3 can be reduced.

In the coil part 1 of the present embodiment, the two coils 2 are electrically connected in series to each other via the connector 23 so that the two coils 2 are deemed to be one coil. In this case, the size of each of the two coils 2 is smaller than in a case where two coils are integrated with each other. The first molded body 3 has a configuration in which one small-size coil 2 is insert molded. This reduces deformation (distortion) of the coil 2 due to molding materials of the first molded body 3 injected into a mold during formation of the first molded body 3. Thus, it is possible to secure an electrical insulation distance which is the distance between the coil 2 encapsulated in the first molded body 3 and the heat dissipation member 7 which is made of metal and to which the first molded body 3 is to be fixed. Therefore, the electric breakdown of the coil 2 can be reduced. Moreover, reducing the deformation of the coil 2 enables variations of the inductance of the coil part 1 to be reduced.

Moreover, the coil part 1 of the present embodiment includes the first magnetic member 41 and the second magnetic member 42 magnetically connectable to the two coils 2. The first magnetic member 41 and the second magnetic member 42 enable the inductance of the coil part 1 to be increased.

Note that the number of coils 2 included in the coil part 1 is not limited to two, but the coil part 1 may include one coil 2 or three or more coils 2. Moreover, in the coil part 1, the two coils 2 electrically connected in series to each other are deemed to be one coil. However, the configuration of the coil part 1 is not limited to this configuration, but the coil part 1 may be a transformer.

Moreover, the coil part 1 of the present embodiment includes the temperature detector 8 for detecting the temperature of the coil 2. The temperature detector 8 is positioned by the positioning section 34 provided to the first molded body 3. This improves the positional accuracy of the temperature detector 8, reduces variations of the distance between the coil 2 and the temperature detector 8, and enables the detection accuracy of the temperature of the coil 2 to be improved. Furthermore, since each first molded body 3 is made of a material containing the filler, the thermal resistance between the coil 2 and the temperature detector 8 is reduced, and it becomes possible to further improve the detection accuracy of the temperature of the coil 2.

Moreover, the first molded bodies 3 include the plurality of positioning sections 34, and therefore, the degree of freedom concerning the location of the temperature detector 8 increases. Furthermore, since in the coil part 1 of the present embodiment, each of the two first molded bodies 3 has the plurality of positioning sections 34, the degree of freedom concerning the location of the temperature detector 8 further increases. Note that a configuration in which only one of the two first molded bodies 3 has the positioning sections 34 may be possible.

Each positioning section 34 is the recess 341 formed in the first molded body 3. Thus, the temperature detector 8 is inserted into the recess 341 until the temperature detector 8 contacts the bottom part of the recess 341, which enables the temperature detector 8 to be positioned, thereby facilitating the step of positioning the temperature detector 8. Moreover, since the recess 341 serving as the positioning section 34 is a part of the first molded body 3, it is not necessary to form the positioning section 34 as a separate component different from the first molded body 3, which can reduce cost. Furthermore, since the recesses 341 serving as the positioning sections 34 are formed during formation of the first molded body 3, a step of forming only the positioning sections 34 is no longer necessary.

Moreover, the first molded body 3 includes the limiter 33 which limits the insertion distance of the first magnetic member 41 into the first insertion hole 321 and the insertion distance of the second magnetic member 42 into the second insertion hole 322. The limiter 33 enables the positional accuracy of the first magnetic member 41 and the second magnetic member 42 with respect to the coil 2 encapsulated in the first molded body 3 to be improved and variations of the inductance of the coil part 1 to be reduced. The limiter 33 also limits both the insertion distance of the first magnetic member 41 and the insertion distance of the second magnetic member 42. Thus, it becomes possible to improve the accuracy of a gap length which is the distance between the first magnetic member 41 and the second magnetic member 42.

Moreover, the limiter 33 is a part of the first molded body 3 and is a partition 331 serving also as the bottom part of the first insertion hole 321 and the bottom part of the second insertion hole 322. Thus, it is not necessary to form the limiter 33 as a separate component different from the first molded body 3, which can reduce cost. Moreover, since the partition 331 serving as the limiter 33 is formed during formation of the first molded body 3, a step of forming only the partition 331 is no longer necessary. Moreover, the partition 331 is provided between the first magnetic member 41 and the second magnetic member 42. This reduces vibration generated due to the magnetostriction phenomenon of the magnetic members 4 when an alternate current flows through the coil 2, which enables noise to be reduced.

<Variations>

Next, variations of the coil part 1 of the present embodiment will be described. Note that components similar to those in the coil part 1 of the embodiment are denoted by the same reference signs as those in the embodiment, and the description thereof is omitted.

<First Variation>

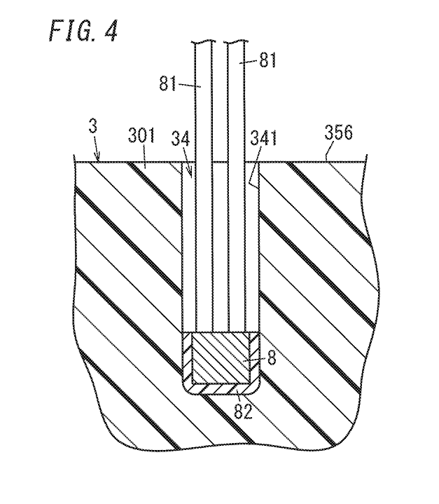

As illustrated in FIG. 4, a coil part 1 of a first variation includes a connection member 82 connecting a temperature detector 8 to a positioning section 34. The connection member 82 is made of, for example, an epoxy resin, is disposed between an inner peripheral surface of a recess 341 serving as the positioning section 34 and the temperature detector 8, and connects the temperature detector 8 to the inner peripheral surface of the recess 341. Since the connection member 82 fixes the temperature detector 8 to the positioning section 34, displacement of the temperature detector 8 due to molding materials of a second molded body 5 during formation of the second molded body 5 is reduced, thereby further improving the positional accuracy of the temperature detector 8.

Moreover, the connection member 82 preferably includes a component containing a resin and a filler having a higher thermal conductivity than the resin. This enables the thermal resistance between the temperature detector 8 and a first molded body 3 to be reduced and enables the detection accuracy of the temperature of a coil 2 by the temperature detector 8 to be improved.

<Second Variation>

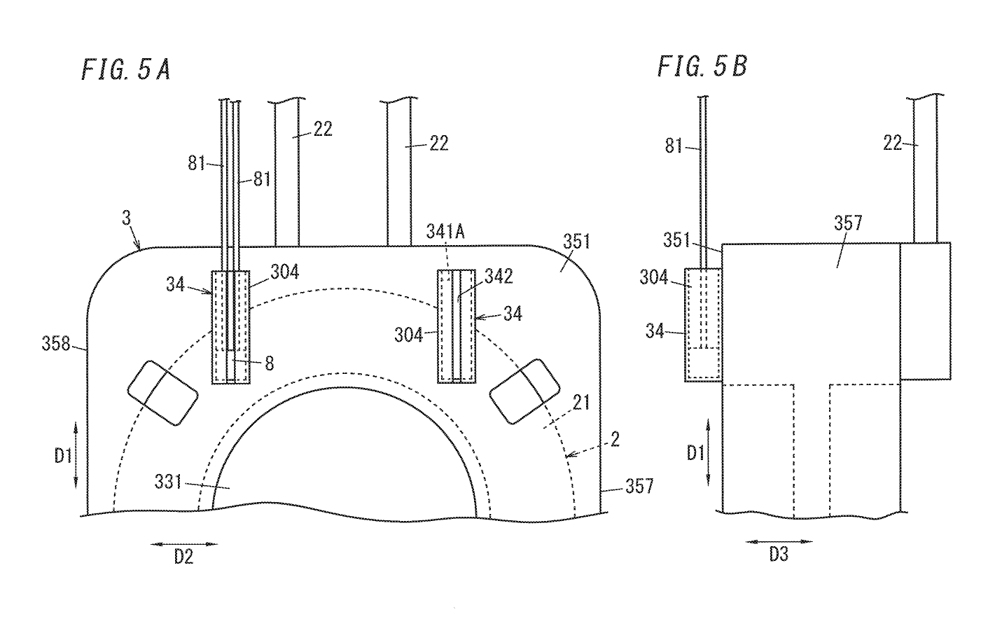

A coil part 1 of a second variation is different from the coil part 1 of the embodiment in the configuration of a positioning section 34. As illustrated in FIGS. 5A and 5B, positioning sections 34 for positioning a temperature detector 8 are disposed in protrusions 304 protruding from a first surface 351 serving as an outer peripheral surface of a first molded body 3. The two protrusions 304 are arranged in the second direction D2 from the first surface 351 of the first molded body 3. The two protrusions 304 are part of the first molded body 3 and are formed during formation of the first molded body 3.

Each protrusion 304 has a cylindrical shape having a recess 341A with a bottom part on a side facing a seat 302 (see FIGS. 3A and 3C) in the third direction D3. The temperature detector 8 is inserted into the recess 341A until the temperature detector 8 contacts the bottom part of the recess 341A, thereby positioning the temperature detector 8. The positioning section 34 is disposed in the protrusion 304 protruding from the first surface 351 of the first molded body 3, and thus, a body 301 no longer requires a space where a recess 341 is to be formed. Thus, the first molded body 3 can be downsized. Note that a surface on which the protrusion 304 is provided is not limited to the first surface 351 of the body 301, but the projection 304 may be provided on a fourth surface 357 or a fifth surface 358 orthogonal to the second direction D2. Thus, it becomes possible to position the temperature detector 8 in a location which is located between two coils 2 in the coil part 1 and in which the temperature easily becomes relatively high.

Moreover, the recess 341A is configured such that the diameter of the recess 341A is substantially equal to the outer diameter of the temperature detector 8, and a slit 342 is also formed in the protrusion 304 along the first direction D1. The temperature detector 8 is inserted to expand the recess 341A. In this way, the temperature detector 8 is fixed by being clamped by the inner peripheral surface of the recess 341A, and therefore, displacement of the temperature detector 8 due to the molding materials of a second molded body 5 during formation of the second molded body 5 is reduced, thereby further improving the positional accuracy of the temperature detector 8.

<Third Variation>

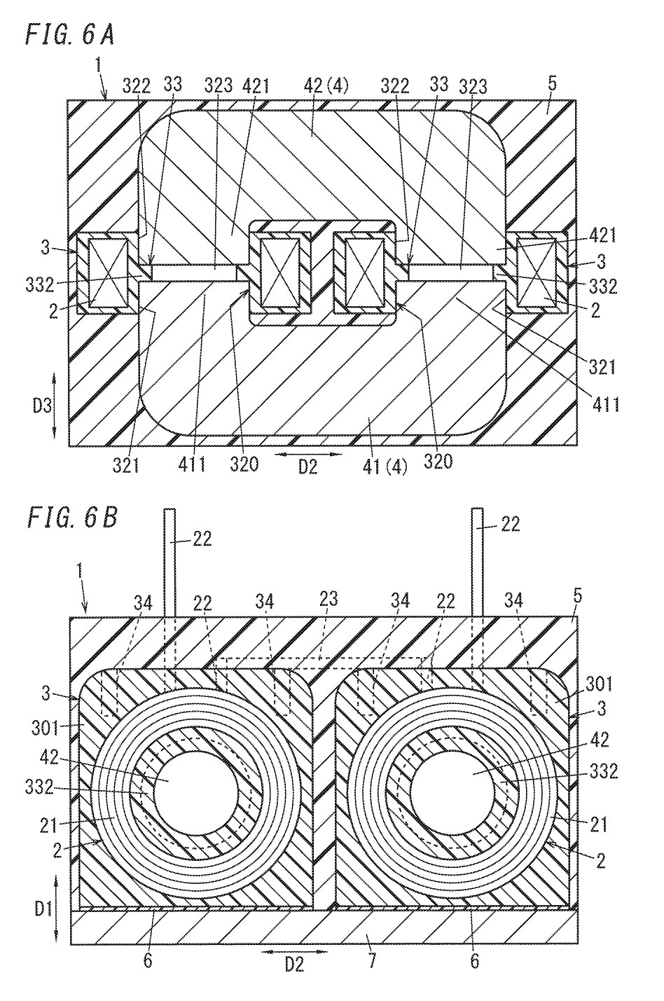

A coil part 1 of a third variation is different from the coil part 1 of the embodiment in terms of the configuration of limiters 33. As illustrated in FIGS. 6A and 6B, the coil part 1 of the present variation includes first molded bodies 3 each of which has a through hole 320 including a first insertion hole 321 and a second insertion hole 322, and the limiter 33 is formed as a protrusion 332 protruding from an inner peripheral surface of the through hole 320.

The protrusion 332 has an annular shape protruding from a substantially center portion in the third direction D3 of the through hole 320 along the entire periphery of the inner peripheral surface of the through hole 320. An end 411 of a first magnetic member 41 contacts the protrusion 332, and thereby, the insertion distance of the first magnetic member 41 into the first insertion hole 321 is limited. An end 421 of a second magnetic member 42 contacts the protrusion 332, and thereby, the insertion distance of the second magnetic member 42 into the second insertion hole 322 is limited. In this way, it becomes possible to improve the accuracy of a gap length which is the distance between the first magnetic member 41 and the second magnetic member 42. Moreover, since an inner side of the protrusion 332 is a space 323, the number of members constituting the coil part 1 can be reduced.

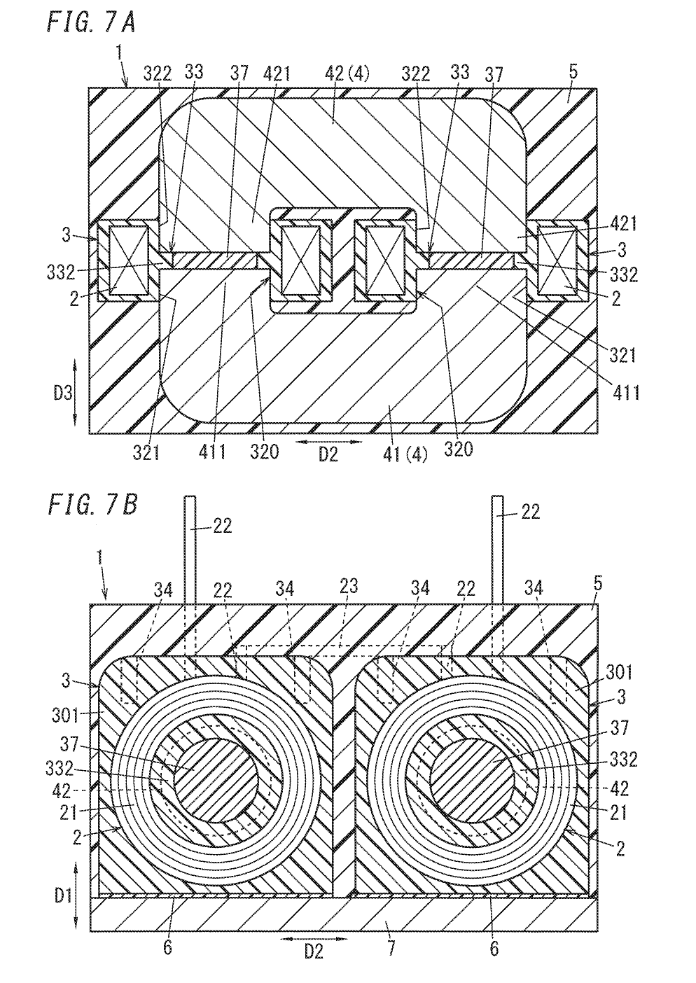

Alternatively, as illustrated in FIGS. 7A and 7B, gap members 37 each may be provided on the inner side of the protrusion 332. Each gap member 37 includes a component containing a resin and is a component different from the first molded body 3. The gap members 37 are provided between the first magnetic member 41 and the second magnetic member 42. This reduces vibration generated due to the magnetostriction phenomenon of the magnetic members 4 when an alternate current flows through a coil 2, which enables noise to be reduced. Since each gap member 37 is a component separate from the first molded body 3, any component suitable for reducing noise is adoptable as the gap member 37 so as to further reduce the noise.

The gap members 37 may be made of the same material as a second molded body 5. Thus, the gap member 37 can be formed during formation of the second molded body 5, and thus, a step of forming only the gap member 37 is no longer necessary.

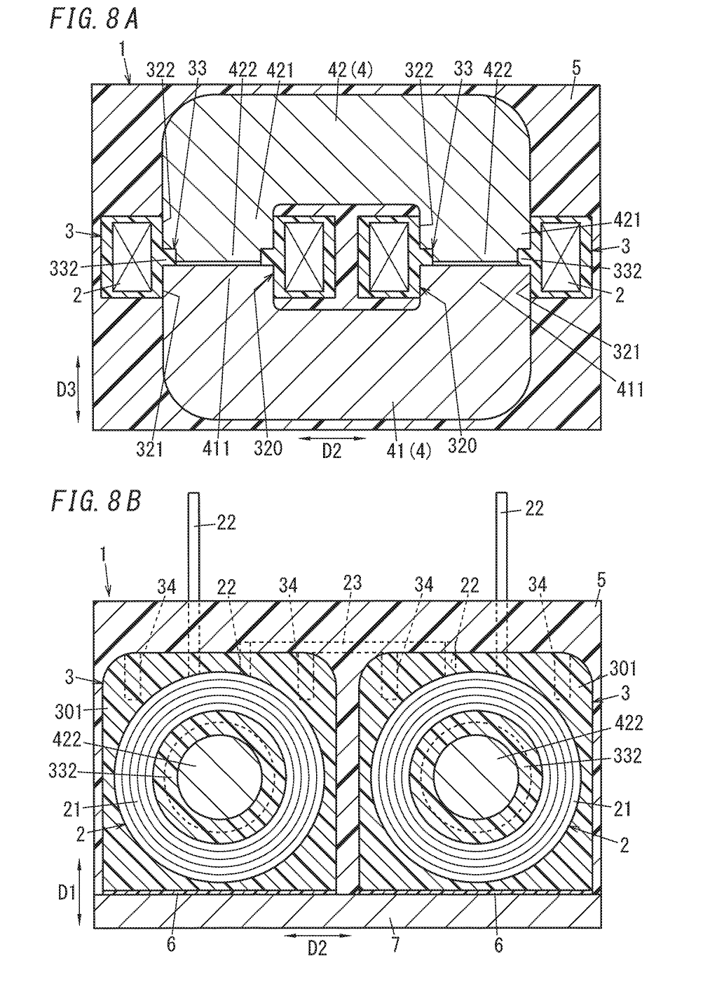

Alternatively, as illustrated in FIGS. 8A and 8B, each end 421 of the second magnetic member 42 may have a projection 422 located on the inner side of the protrusion 332. The projection 422 has a cylindrical shape and faces the end 411 of the first magnetic member 41. The projection 422 enters the inner side of the protrusion 332, and thereby, a gap length which is the distance between the first magnetic member 41 and the second magnetic member 42 can be reduced to be shorter than the dimension in the third direction D3 of the protrusion 332.

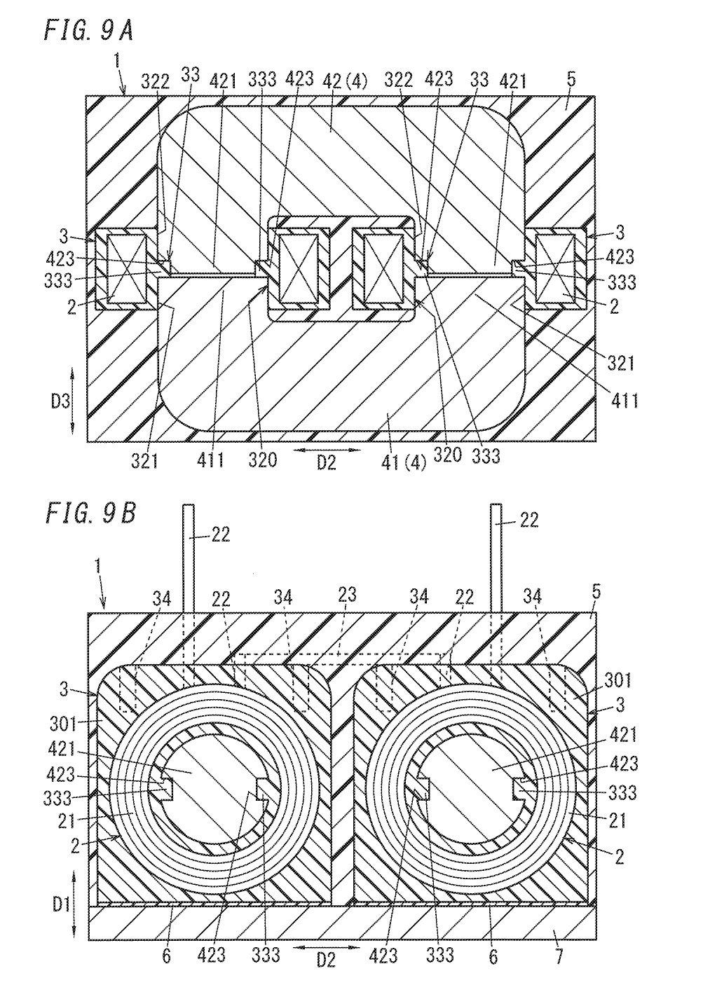

Alternatively, as illustrated in FIGS. 9A and 9B, the limiter 33 may correspond to protrusions 333 protruding from a part of the inner peripheral surface of the through hole 320. Two protrusions 333 protrude from the inner peripheral surface of the through hole 320, and the two protrusions 333 face each other in the second direction D2. Moreover, each end 421 of the second magnetic member 42 has two recesses 423 which engage with the two protrusions 333. The two recesses 423 formed in each end 421 of the second magnetic member 42 engage with the two protrusions 333 provided to the inner peripheral surface of the through hole 320, and thereby, a gap length which is the distance between the first magnetic member 41 and the second magnetic member 42 can be reduced to be shorter than the dimension in the third direction D3 of the protrusion 333.

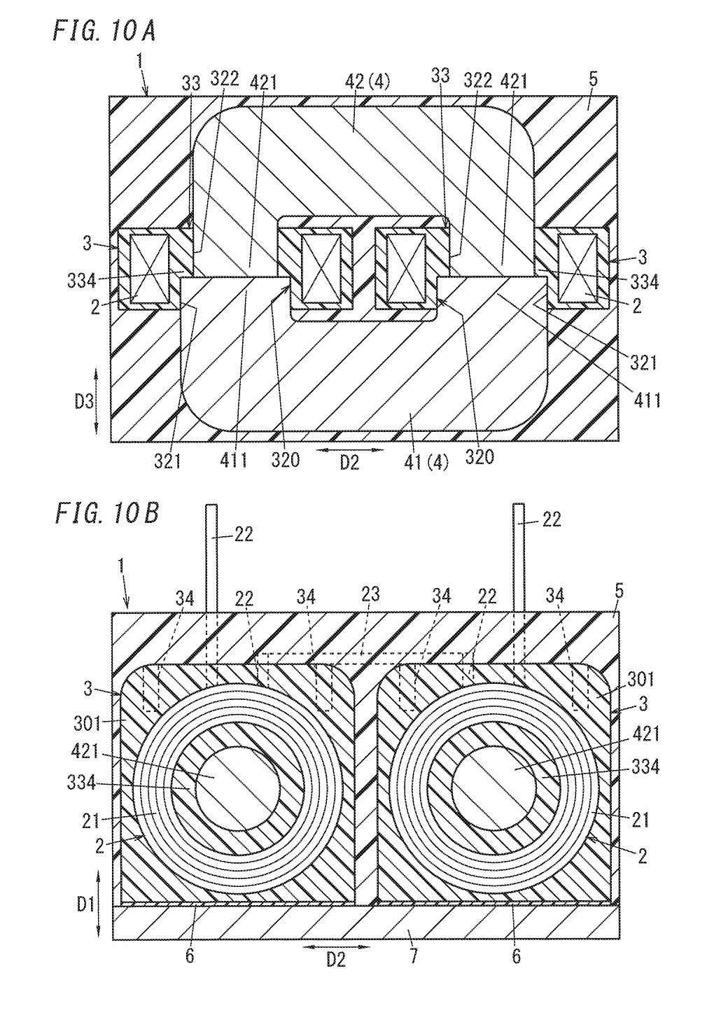

Alternatively, as illustrated in FIGS. 10A and 10B, each limiter 33 may limit only the insertion distance of the first magnetic member 41 into the first insertion hole 321. The limiter 33 is a protrusion 334 protruding from the inner peripheral surface of the through hole 320. The protrusion 334 protrudes from a substantially center portion in the third direction D3 of the through hole 320, over an opening edge of the second insertion hole 322, along the entire periphery of the inner peripheral surface of the through hole 320. Due to the protrusion 334, the diameter of the second insertion hole 322 is smaller than the diameter of the first insertion hole 321. Each end 421 of the second magnetic member 42 is dimensioned such that the end 421 is insertable into the second insertion hole 322, and the diameter of the end 421 is smaller than the diameter of the end 421 of the first magnetic member 41. The first magnetic member 41 is inserted into first insertion hole 321 until the end 411 contacts the protrusion 334. The second magnetic member 42 is inserted into the second insertion hole 322 until the end 421 contacts the end 411 of the first magnetic member 41. That is, the insertion distance of the first magnetic member 41 is limited by the protrusion 334 serving as the limiter 33, and the insertion distance of the second magnetic member 42 is limited by the first magnetic member 41 inserted into the first insertion hole 321. This enables the positional accuracy of the first magnetic member 41 and the second magnetic member 42 with respect to the coil 2 to be improved and variations of the inductance of the coil part 1 to be reduced.

<Fourth Variation>

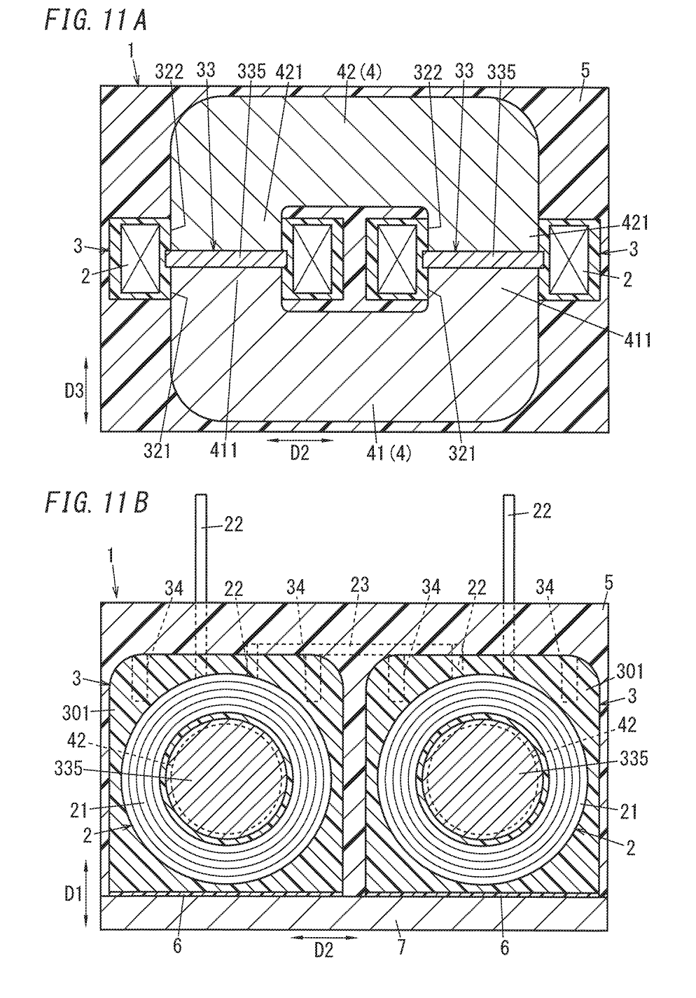

A coil part 1 of a fourth variation is different from the coil part 1 of the embodiment in terms of the configuration of limiters 33. As illustrated in FIGS. 11A and 11B, the coil part 1 of the present variation includes limiters 33 each of which is a partition member 335 separate from first molded bodies 3. The partition member 335 is made of, for example, ceramic and has a plate shape. The partition member 335 is insert molded in a first molded body 3, has a thickness direction corresponding to the third direction D3, and is held by the first molded body 3 to separate a first insertion hole 321 from a second insertion hole 322. The partition member 335 also serves as a bottom part of the first insertion hole 321 and a bottom part of the second insertion hole 322. An end 411 of a first magnetic member 41 contacts the partition member 335, and thereby, the insertion distance of the first magnetic member 41 into the first insertion hole 321 is limited. An end 421 of the second magnetic member 42 contacts the partition member 335, and thereby, the insertion distance of the second magnetic member 42 into the second insertion hole 322 is limited. Thus, it becomes possible to improve the accuracy of a gap length which is the distance between the first magnetic member 41 and the second magnetic member 42.

The partition members 335 are provided between the first magnetic member 41 and the second magnetic member 42. This reduces vibration generated due to the magnetostriction phenomenon of the magnetic members 4 when an alternate current flows through a coil 2, which enables noise to be reduced. Since the partition members 335 are components separate from the first molded body 3 and a second molded body 5, any component suitable for reducing noise is adoptable as the partition member 335 so as to further reduce the noise.

<Fifth Variation>

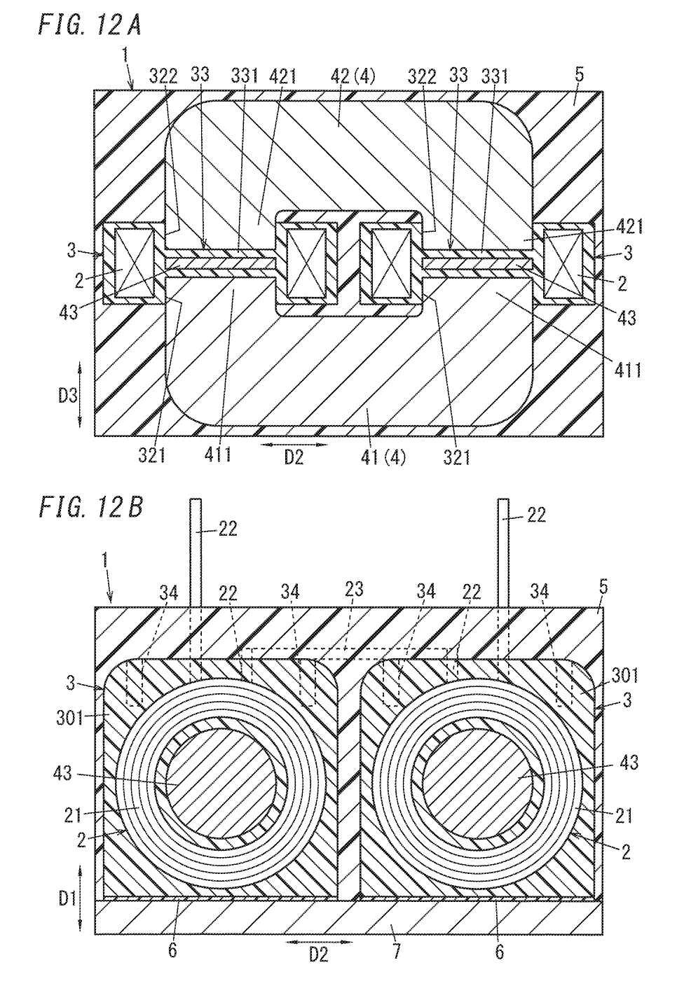

A coil part 1 of a fifth variation is different from the coil part 1 of the embodiment in terms of the configuration of limiters 33. As illustrated in FIGS. 12A and 12B, the coil part 1 of the present variation includes limiters 33 each of which includes a third magnetic member 43. The third magnetic member 43 is formed of, for example, a powder magnetic core and has a plate shape. The third magnetic member 43 is insert molded in each first molded body 3. The thickness direction of the third magnetic member 43 corresponds to third direction D3. The third magnetic member 43 is disposed on an inner side of a partition 331 and is magnetically connected to a coil 2. The third magnetic member 43 faces an end 411 of a first magnetic member 41 and an end 421 of a second magnetic member 42 via a part of the partition 331 in the third direction D3. Thus, the first magnetic member 41, the second magnetic member 42, and the two third magnetic members 43 form a magnetic circuit. A magnetic gap is formed between the end 411 of the first magnetic member 41 and the third magnetic member 43 and between the end 421 of the second magnetic member 42 and the third magnetic member 43. That is, the coil part 1 of the present variation includes the third magnetic members 43, and thus, the number of magnetic gaps is increased.

The number of magnetic gaps is increased, and thus, electromagnetic force applied to one magnetic gap decreases. This reduces vibration caused due to magnetostriction phenomenon of the first magnetic member 41, the second magnetic member 42, and the third magnetic member 43 in the vicinity of the magnetic gap, which enables noise to be reduced.

Note that each partition member 335 (see FIGS. 11A and 11B) included in the coil part 1 of the fourth variation may include the third magnetic member 43.

<Summary>

As described above, a coil part 1 according to a first aspect includes two coils 2, two first molded bodies 3, and a second molded body 5. The two first molded bodies 3 serving as electrical insulation individually cover the two coils 2. The second molded body 5 serving as electrical insulation integrally covers the two first molded bodies 3. The second molded body 5 has a modulus of elasticity lower than a modulus of elasticity of each of the two first molded bodies 3.

With this configuration, the two first molded bodies 3 individually cover the two coils 2. Therefore, the occurrence of a void during formation of each first molded body 3 is reduced, and the heat dissipation characteristic of each first molded body 3 is improved. Thus, it becomes possible to improve the heat dissipation characteristic of the coil part 1. Moreover, with this configuration, vibration and noise generated due to a magnetostriction phenomenon of a magnetic member 4 when an alternate current flows through the coil 2 can be reduced by being absorbed by the second molded body 5.

In a coil part 1 according to a second aspect referring to the first aspect, each of the two first molded bodies 3 preferably has a thermal conductivity higher than a thermal conductivity of the second molded body 5.

This configuration improves the heat dissipation characteristic of the first molded bodies 3 and it becomes possible to further improve the heat dissipation characteristic of the coil part 1.

In a coil part 1 according to a third aspect referring to the first or second aspect, each of the two first molded bodies 3 and the second molded body 5 preferably contains a resin and a filler having a higher thermal conductivity than the resin. A filler content of each of the two first molded bodies 3 is preferably higher than a filler content of the second molded body 5.

This configuration improves the heat dissipation characteristic of the first molded bodies 3 and it becomes possible to further improve the heat dissipation characteristic of the coil part 1.

In a coil part 1 according to a fourth aspect referring to any one of the first to third aspects, each of the two first molded bodies 3 preferably has specific gravity higher than specific gravity of the second molded body 5.

This configuration improves the heat dissipation characteristic of the first molded bodies and it becomes possible to further improve the heat dissipation characteristic of the coil part 1.

A coil part 1 according to a fifth aspect referring to any one of the first to fourth aspects preferably further includes a first magnetic member 41 and a second magnetic member 42. The first magnetic member 41 is preferably magnetically connectable to the two coils 2. The second magnetic member is preferably magnetically connectable to the two coils 2. Each of the two first molded bodies 3 preferably has a first insertion hole 321, a second insertion hole 322, and a limiter 33. The first insertion hole 321 is preferably formed on one side in an axial direction of a corresponding one of the two coils 2, and a part (an end 411) of the first magnetic member 41 is preferably inserted into the first insertion hole 321. The second insertion hole 322 is preferably formed on the other side in the axial direction of the corresponding one of the two coils 2, and a part (end 421) of the second magnetic member 42 is preferably inserted into the second insertion hole 322. The limiter 33 preferably limits at least one of an insertion distance of the first magnetic member 41 into the first insertion hole 321 and an insertion distance of the second magnetic member 42 into the second insertion hole 322.

This configuration enables the positional accuracy of the first magnetic member 41 and the second magnetic member 42 with respect to the coil 2 encapsulated in the first molded body 3 to be improved and variations of the inductance of the coil part 1 to be reduced. Moreover, this configuration enables the inductance of the coil part 1 to be improved.

A coil part 1 according to a sixth aspect referring to any one of the first to fifth aspects preferably further includes a temperature detector 8. The temperature detector 8 preferably detects a temperature of the two coils 2. At least one of the two first molded bodies 3 preferably includes a positioning section 34 for positioning the temperature detector 8.

This configuration improves the positional accuracy of the temperature detector 8, reduces variations of the distance between the coil 2 and the temperature detector 8, and enables the detection accuracy of the temperature of the coil 2 to be improved.

Alternatively, a coil part 1 according to a seventh aspect includes two coils 2, two first molded bodies 3, and a second molded body 5. The two first molded bodies 3 serving as electrical insulation individually cover the two coils 2. The second molded body 5 serving as electrical insulation integrally covers the two first molded bodies 3.

With this configuration, the two first molded bodies 3 individually cover the two coils 2. Therefore, the occurrence of a void during formation of each first molded body 3 is reduced, and the heat dissipation characteristic of each first molded body 3 is improved. Thus, it becomes possible to improve the heat dissipation characteristic of the coil part 1.

In a coil part 1 according to an eighth aspect referring to the seventh aspect, each of the two first molded bodies 3 and the second molded body 5 contains a resin and a filler having a higher thermal conductivity than the resin. A filler content of each of the two first molded bodies 3 is higher than a filler content of the second molded body 5.

This configuration improves the heat dissipation characteristic of the first molded bodies 3 and it becomes possible to further improve the heat dissipation characteristic of the coil part 1.

In a coil part 1 according to a ninth aspect referring to the seventh or eighth aspect, each of the two first molded bodies 3 has specific gravity higher than specific gravity of the second mold 5.

This configuration improves the heat dissipation characteristic of the first molded bodies 3 and it becomes possible to further improve the heat dissipation characteristic of the coil part 1.

In a coil part 1 according to a tenth aspect referring to any one of the seventh to ninth aspects, each of the two first molded bodies 3 has a thermal conductivity higher than a thermal conductivity of the second molded body 5.

This configuration improves the heat dissipation characteristic of the first molded bodies 3 and it becomes possible to further improve the heat dissipation characteristic of the coil part 1.

A coil part 1 according to an eleventh aspect referring to any one of the seventh to tenth aspects further includes a magnetic member 4 magnetically connectable to the two coils 2.

This configuration enable the inductance of the coil part 1 to be increased.

A coil part 1 according to a twelfth aspect referring to any one of the seventh to eleventh aspects further includes a connector 23 for electrically connecting one end (terminal 22) of one of the two coils 2 to one end of the other one of the two coils 2.

This configuration reduces deformation of each coil 2 more than the configuration in which two coils are integrally formed, and thus, this configuration enables variations of the inductance to be reduced.

In a coil part 1 according to a thirteenth aspect referring to any one of the seventh to twelfth aspects, the second molded body 5 has a modulus of elasticity lower than a modulus of elasticity of each of the two first molded bodies 3.

With this configuration, vibration and noise generated due to a magnetostriction phenomenon of the magnetic member 4 when an alternate current flows through the coil 2 can be reduced by being absorbed by the second molded body 5.

A coil part 1 according to a fourteenth aspect referring to any one of seventh to thirteenth aspects further includes a heat dissipation member 7 and a thermal bonding member 6.

The thermal bonding member 6 is disposed between a heat dissipation member 7 and each of the two first molded bodies 3 to thermally connect the two first molded bodies 3 to the heat dissipation member 7.

This configuration reduces the thermal resistance between each first molded bodies 3 and the heat dissipation member 7, improves the heat dissipation characteristic of the first molded bodies 3, and it becomes possible to further improve the heat dissipation characteristic of the coil part 1.

In a coil part 1 according to a fifteenth aspect referring to the fourteenth aspect, the thermal bonding member 6 connects the two first molded bodies 3 to the heat dissipation member 7.

With this configuration, it becomes possible to improve the fixing strength of the first molded body 3 with respect to the heat dissipation member 7.

In a coil part 1 according to a sixteenth aspect referring to the fourteenth or fifteenth aspect, each of the two first molded bodies 3 and the thermal bonding member 6 contains a resin and a filler having a higher thermal conductivity than the resin. A filler content of the thermal bonding member 6 is higher than a filler content of each of the two first molded bodies 3.

With this configuration, it becomes possible to further improve the heat dissipation characteristic of the coil 2.

In a coil part 1 according to a seventeenth aspect referring to any one of the fourteenth to sixteenth aspects, the thermal bonding member 6 has specific gravity higher than specific gravity of each of the two first molded bodies 3.

This configuration improves the heat dissipation characteristic of the first molded bodies 3 and it becomes possible to further improve the heat dissipation characteristic of the coil part 1.

In a coil part 1 according to an eighteenth aspect referring to any one of the fourteenth to seventeenth aspects, the thermal bonding member 6 has a thermal conductivity higher than a thermal conductivity of each of the two first molded body 3.

This configuration improves the heat dissipation characteristic of the first molded bodies 3, and it becomes possible to further improve the heat dissipation characteristic of the coil part 1.

A coil part 1 according to a nineteenth aspect includes a coil 2, a first molded body 3 (molded body), a first magnetic member 41, and a second magnetic member 42. The first molded body 3 serving as electrical insulation covers the coil 2. The first magnetic member 41 is magnetically connectable to the coil 2. The second magnetic member 42 is magnetically connectable to the coil 2. The first molded body 3 includes a first insertion hole 321, a second insertion hole 322, and a limiter 33. The first insertion hole 321 is formed on one side in the axial direction of the coil 2, and a part (an end 411) of the first magnetic member 41 is inserted into the first insertion hole 321. The second insertion hole 322 is formed on the other side in the axial direction of the coil 2, and a part (end 421) of the second magnetic member 42 is inserted into the second insertion hole 322. The limiter 33 limits at least one of an insertion distance of the first magnetic member 41 into the first insertion hole 321 and an insertion distance of the second magnetic member 42 into the second insertion hole 322.

This configuration enables the positional accuracy of the first magnetic member 41 and the second magnetic member 42 with respect to the coil 2 encapsulated in the first molded body 3 to be improved and variations of the inductance of the coil part 1 to be reduced.

In a coil part 1 according to a twentieth aspect referring to the nineteenth aspect, the limiter 33 limits both the insertion distance of the first magnetic member 41 into the first insertion hole 321 and the insertion distance of the second magnetic member 42 into the second insertion hole 322.

With this configuration, it becomes possible to improve the accuracy of a gap length which is the distance between the first magnetic member 41 and the second magnetic member 42

In a coil part 1 according to a twenty-first aspect referring to the twentieth aspect, the limiter 33 is a part of the first molded body 3 and is a partition 331 serving also as a bottom part of the first insertion hole 321 and a bottom part of the second insertion hole 322.

With this configuration, it is not necessary to form the limiter 33 as a separate component different from the first molded body 3, which can reduce cost. Moreover, vibration generated due to the magnetostriction phenomenon of the first magnetic member 41 and the second magnetic member 42 when an alternate current flows through the coil 2 is reduced, and thus, it becomes possible to reduce noise.

In a coil part 1 according to a twenty-second aspect referring to the twentieth aspect, the limiter 33 is held by the first molded body 3 and is a partition member 335 also serving as a bottom part of the first insertion hole 321 and a bottom part of the second insertion hole 322.

With this configuration, any component suitable to reduce noise generated due to the magnetostriction phenomenon of the first magnetic member 41 and the second magnetic member 42 when an alternate current flows through the coil 2 is adoptable as the partition member 335, and thus, it becomes possible to reduce the noise.

In a coil part 1 according to a twenty-third aspect referring to the twenty-first or twenty-second aspect, the limiter 33 includes a third magnetic member 43 magnetically connectable to the coil 2.

This configuration reduces vibration of the first magnetic member 41, the second magnetic member 42, and the third magnetic member 43 due to the magnetostriction phenomenon, and thus, it becomes possible to reduce the noise.

In a coil part 1 according to a twenty-fourth aspect referring to the twentieth aspect, the first molded body 3 has a through hole 320 including the first insertion hole 321 and the second insertion hole 322 which are in communication with each other. The limiter 33 is a protrusion 332 protruding from an inner peripheral surface of the through hole 320.

With this configuration, the number of members constituting the coil part 1 can be reduced.

A coil part 1 according to a twenty-fifth aspect referring to the twenty-fourth aspect further includes a gap member 37 disposed between the first magnetic member 41 and the second magnetic member 42.

With this configuration, vibration generated due to the magnetostriction phenomenon of the first magnetic member 41 and the second magnetic member 42 when an alternate current flows through the coil 2 is reduced, and thus, it becomes possible to reduce noise. Since the gap member 37 is a component different from the first molded body 3, any component suitable for reducing noise can be adopted to further reduce the noise.

A coil part 1 according to a twenty-sixth aspect referring to any one of the nineteenth to twenty-fifth aspects further includes a second molded body 5 integrally covering the first molded body 3, the first magnetic member 41, and the second magnetic member 42.

This configuration enables vibration generated due to the magnetostriction phenomenon of the first magnetic member 41 and the second magnetic member 42 when an alternate current flows through the coil 2 to be reduced, and it becomes possible to reduce the noise.

In a coil part 1 according to a twenty-seventh aspect referring to any one of the nineteenth to twenty-sixth aspects, the coil 2 includes two coils 2, and the first molded body 3 includes two first molded bodies 3. Parts (ends 411) of the first magnetic member 41 are inserted into first insertion holes 321 of the two first molded bodies 3 to magnetically connect the first magnetic member 41 to the two coils 2. Part (ends 421) of the second magnetic member 42 are inserted into second insertion holes 322 of the two first molded bodies 3 to magnetically connect the second magnetic member 42 to the two coils 2.

This configuration enables the inductance of the coil part 1 to be improved.

A method for fabricating a coil part 1 according to a twenty-eighth aspect is a method for fabricating the coil part 1 according to any one of the nineteenth to twenty-seventh aspect, the method including a preparation step (first step), a first formation step (second step), and a assembling step (third step), in the preparation step, a coil 2 is prepared. In the first formation step, a first molded body 3 covering the coil 2 and including a limiter 33 is formed. In the assembling step, a first magnetic member 41 is inserted into a first insertion hole 321 and a second magnetic member 42 is inserted into a second insertion hole 322.

This method enables the coil part 1 capable of reducing variations of the inductance to be fabricated.

A coil part 1 according to a twenty-ninth aspect includes a coil 2, a first molded body 3 (molded body), and a temperature detector 8. The first molded body 3 serving as electrical insulation covers the coil 2. The temperature detector 8 is configured to detect a temperature of the coil 2. The first molded body 3 includes a positioning section 34 for positioning the temperature detector 8.

This configuration improves the positional accuracy of the temperature detector 8, reduces variations of the distance between the coil 2 and the temperature detector 8, and enables the detection accuracy of the temperature of the coil 2 to be improved.

In a coil part 1 according to a thirtieth aspect referring to the twenty-ninth aspect, the positioning section 34 of the first molded body 3 includes a plurality of the positioning sections 34. The temperature detector 8 is positioned by any one of the plurality of positioning sections 34.

This configuration increases the degree of freedom concerning the location of the temperature detector 8.

In a coil part 1 according to a thirty-first aspect referring to the twenty-ninth or thirtieth aspect, the coil 2 includes a plurality of coils 2, and the first molded body 3 includes a plurality of first molded bodies 3. The temperature detector 8 is positioned by the positioning section 34 included in any one of the plurality of first molded bodies 3 or one of the positioning sections 34 included in any one of the plurality of first molded bodies 3.

This configuration increases the degree of freedom concerning the location of the temperature detector 8 increases.

A coil part 1 according to a thirty-second aspect referring to any one of the twenty-ninth to thirty-first aspects further includes a second molded body 5 serving as electrical insulation integrally covering the first molded body 3 and the temperature detector 8.

With this configuration, it is possible to fix the temperature detector 8 positioned by the positioning section 34.

In a coil part 1 according to a thirty-third aspect referring to any one of the twenty-ninth to thirty-second aspects, the positioning section 34 is formed in the first molded body 3 and is a recess 341 (341A) into which the temperature detector 8 is insertable.

With this configuration, the temperature detector 8 is inserted into the recess 341 (341A) until the temperature detector 8 contacts the bottom part of the recess 341 (341A), which enables the temperature detector 8 to be positioned, thereby facilitating the step of positioning the temperature detector 8.

In a coil part 1 according to a thirty-fourth aspect referring to any one of the twenty-ninth to thirty-second aspects, the positioning section 34 is disposed in a protrusion 304 protruding from an outer peripheral surface of the first molded body 3.

With this configuration, the first molded body 3 can be downsized.

A coil part 1 according to a thirty-fifth aspect referring to any one of the twenty-ninth to thirty-fourth aspect further includes a connection member 82 connecting the temperature detector 8 to the positioning section 34.

This configuration reduces the positional displacement of the temperature detector 8, further improves the positional accuracy of the temperature detector 8, and further improves the detection accuracy of the temperature of the coil 2.

A coil part 1 according to a thirty-sixth aspect referring to any one of the twenty-ninth to thirty-fifth aspects further includes a heat dissipation member 7 thermally connectable to the first molded body 3.

This configuration improves the heat dissipation characteristic of the first molded body 3, which enables the coil 2 to efficiently dissipate heat.

In a coil part 1 according to a thirty-seventh aspect referring to any one of twenty-ninth to thirty sixth aspects, the first molded body 3 contains a resin and a filler having a higher thermal conductivity then the resin.

With this configuration, the thermal resistance between the coil 2 and the temperature detector 8 is reduced, and it becomes possible to further improve the detection accuracy of the temperature of the coil 2.

A method for fabricating the coil part 1 according to a thirty-eighth aspect is a method for fabricating the coil part 1 according to any one of the twenty-ninth to thirty-seventh aspects, the method including a preparation step (first step), a first formation step (second step), and a second formation step (third step). In the preparation step, a coil 2 is prepared. In the first formation step, a first molded body 3 (molded body) covering the coil 2 and having a positioning section 34 is formed. In the second formation step, the temperature detector 8 is fixed to the positioning section 34.

This method enables a coil part 1 capable of improving the detection accuracy of the temperature of the coil 2 to be fabricated.

Note that the above-described embodiment is a mere example of the present invention. Therefore, the present invention is not limited to the above-described embodiment. Even in configurations other than that illustrated in this embodiment, various modifications may be made depending on design and the like without departing from the technical idea of the present invention.

### REFERENCE SIGNS LIST

1 Coil Part
2 Coil
23 Connector
3 First Molded Body
321 First Insertion Hole
322 Second Insertion Hole
33 Limiter
34 Positioning Section
41. First Magnetic Member
42 Second Magnetic Member
5 Second Molded Body
6 Thermal Bonding Member
7 Heat Dissipation Member
8 Temperature Detector

1. A coil part, comprising:
two coils;
two first molded bodies serving as electrical insulation individually covering the two coils; and
a second molded body serving as electrical insulation integrally covering the two first molded bodies,
the second molded body having a modulus of elasticity lower than a modulus of elasticity of each of the two first molded bodies.

2. The coil part according to claim 1, wherein
each of the two first molded bodies has a thermal conductivity higher than a thermal conductivity of the second molded body.

3. The coil part according to claim 1, wherein
each of the two first molded bodies and the second molded body contains a resin and a filler having a higher thermal conductivity than the resin, and
a filler content of each of the two first molded bodies is higher than a filler content of the second molded body.

4. The coil part according to claim 1, wherein
each of the two first molded bodies has specific gravity higher than specific gravity of the second molded body.

5. The coil part according to claim 1, further comprising:
a first magnetic member magnetically connectable to the two coils; and
a second magnetic member magnetically connectable to the two coils, wherein
each of the two first molded bodies has
a first insertion hole which is formed on one side in an axial direction of a corresponding one of the two coils and into which a part of the first magnetic member is inserted,
a second insertion hole which is formed on the other side in the axial direction of the corresponding one of the two coils and into which a part of the second magnetic member is inserted, and
a limiter which limits at least one of an insertion distance of the first magnetic member into the first insertion hole and an insertion distance of the second magnetic member into the second insertion hole.

6. The coil part according to claim 1,
further comprising a temperature detector configured to detect a temperature of the two coils, wherein
at least one of the two first molded bodies includes a positioning section for positioning the temperature detector.

7. The coil part according to claim 2, further comprising:
a first magnetic member magnetically connectable to the two coils; and
a second magnetic member magnetically connectable to the two coils, wherein
each of the two first molded bodies has
a first insertion hole which is formed on one side in an axial direction of a corresponding one of the two coils and into which a part of the first magnetic member is inserted,
a second insertion hole which is formed on the other side in the axial direction of the corresponding one of the two coils and into which a part of the second magnetic member is inserted, and
a limiter which limits at least one of an insertion distance of the first magnetic member into the first insertion hole and an insertion distance of the second magnetic member into the second insertion hole.

8. The coil part according to claim 2, further comprising a temperature detector configured to detect a temperature of the two coils, wherein
at least one of the two first molded bodies includes a positioning section for positioning the temperature detector.
